(19) United States
(12) Patent Application Publication
(10) Pub. No.: US 2008/0196043 A1
(43) Pub. Date: Aug. 14, 2008

(54) SYSTEM AND METHOD FOR HOST AND VIRTUAL MACHINE ADMINISTRATION

(76) Inventors: David Feinleib, Palo Alto, CA (US); Charles Mount, Issaquah, WA (US); R. Alan Burnett, Bellevue, WA (US)

Correspondence Address: LAW OFFICE OF R. ALAN BURNETT, 4108 131ST AVE. SE, BELLEVUE, WA, 98006, US

(21) Appl. No.: 11/672,944

(22) Filed: Feb. 8, 2007

(51) Int. Cl. G06F 9/54; G06F 9/46; G06F 9/50

(52) U.S. Cl. 719/319; 718/1

(57) ABSTRACT

Methods, architectures, software/firmware and systems for enabling concurrent administration of host operating systems and virtual machine-hosted operating systems. Techniques are disclosed for monitoring and reporting various administrative data (e.g., performance data, event data, log data, etc.), as well as enabling allocation and reallocation of system resources, such as physical memory and disk space. The techniques support implementation of user-interfaces hosted by a virtual machine operating system or a host operating system that enable administrators and the like to manage operations of virtual machines and hosts via a unified interface. Moreover, the techniques support concurrent management of different operating system types.

### FIELD OF THE INVENTION

The field of invention generally relates to administrative tools for computer systems, and more particularly relates to administrative tools and associated methods, architectures, software/firmware and systems for enabling concurrent administration of a virtual machine host and virtual machines running on the host.

### BACKGROUND INFORMATION

It can be appreciated that the use of virtual machines running on servers has become more prevalent in recent years. A virtual machine is an operating environment that runs on a computer to allow multiple operating systems, such as a MICROSOFT™ WINDOWS™ Server (e.g., WINDOWS Server 2003) or a LINUX™ Server (e.g., RED HAT™ LINUX Enterprise Edition 3), to run independently within one or more virtual machines. In most cases, virtual machines simulate complete hardware environments, such that the operating system running within a virtual machine interfaces with what appears to be a computer, when in fact it is a simulated computer running on a computer (i.e., a virtual machine). The advantage of such an arrangement is that multiple virtual machines can run on a single computer, allowing for increased operating efficiency and/or higher reliability due to virtual machine isolation.

However, this configuration presents an interesting problem. One common configuration is that of a server running the LINUX operating system hosting multiple virtual machines running the WINDOWS Server operating system and the LINUX operating system. If a problem occurs in one of the virtual machines, the problem could be due to interference from another virtual machine or a problem with the underlying operating system.

For a computer systems administrator, that is, someone who manages operating system installations, this is a very challenging situation. The problem is that WINDOWS Server administrators are only trained to manage and troubleshoot problems with WINDOWS Server installations, while LINUX administrators are only familiar with how to operate and troubleshoot LINUX installations. Such administrators need access to administrative data such as CPU usage, memory usage, disk usage and error log information such as failed system logon attempts, failed processes, and the like. As a result, a WINDOWS Server administrator encountering a malfunctioning virtual machine in the above configuration (LINUX host running WINDOWS and LINUX virtual machines) is unable to troubleshoot problems in any of the LINUX virtual machines or the LINUX host. Even experienced system administrators who are familiar with both the WINDOWS and LINUX operating systems find such a situation challenging to troubleshoot due to the need to go back and forth between the error logs and performance interfaces located on the host and in the various virtual machines. An additional challenge is that, between different operating systems, administrative data is stored and exposed in different ways, such that performance and event data is not easily transferable between two operating systems running in separate virtual machines. Clearly then, a virtual machine environment running diverse operating systems can present a difficult and challenging configuration to troubleshoot even for the most experienced systems administrators. It would be beneficial, therefore, to devise a technique to expose such administrative data across various virtual machines to make that data easier for systems administrators to access via the operating environment in which they are most comfortable. Moreover, it would be advantageous to enable systems administrators to be able to reconfigure various platform and VM resources via an interface they are familiar with.

### SUMMARY OF THE INVENTION

In accordance with aspects of the invention, methods, architectures and software/firmware components are disclosed for monitoring and reporting administrative data among a virtual machine host and virtual machines running on the host, and for re-allocating platform resources. The disclosed techniques enable administrative data from one or more virtual machines and/or the virtual machine host to be viewed via a “unified” user interface running on the host or any other given virtual machine, regardless of what operating systems the host or virtual machines are running.

In accordance with one aspect of the invention, software and/or firmware components called “agents” are installed and run on a host operating system and respective operating systems running on multiple virtual machines. Optionally, agents may run directly on virtual machines. Generally, such agents may be distributed as modules that are included in the operating system distribution (that is, the files that make up the operating system) or it can be installed by a computer systems administrator or the like via a storage medium or network download. The agents obtain administrative data, such as performance and log data, user information, process information, memory and CPU usage and the like, from their respective host operating systems by monitoring, for example, key log files for changes and by querying processes running on hosts for information. In another implementation, an agent interfaces with its host operating system via an application programming interface that can be configured to notify the agent of changes to administrative data corresponding to its host operating system.

In accordance with another aspect, an agent running on the host operating system publishes administrative data to operating systems running in virtual machines or to agents running on such operating systems. An agent may publish the administrative data through a variety of mechanisms. These include a virtual machine application programming interface, direct writing to the operating systems running within the virtual machines, connection-oriented or connectionless communication mechanisms for publishing such data to software agents running on the operating systems in the virtual machines, and exposing administrative data through polling interfaces.

In accordance with yet another aspect, communication between agents may be implemented via a peer-to-peer, network protocol-based, bus-based or control-based transfer of administrative data among the host and virtual machines. As a result, any given agent, whether running on the host or one of the operating systems hosted by a virtual machine can act as the central point of collection and viewing of administrative data, thereby reducing the dependency on any given virtual machine or the host.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a block schematic diagram of an architecture including software agents that enable communication of various data between a host operating system and one or more operating systems running on virtual machines hosted by a virtual machine platform running on the host operating system.

FIG. 2 is a flowchart illustrating one embodiment of a process flow for hooking host operating system performance data and events and publishing and making that information available to the operating systems running within various virtual machines.

FIG. 3 is a flowchart illustrating one embodiment of a process for publishing performance data between the host and the operating systems of various virtual machines.

FIG. 4 is a flowchart illustrating one embodiment of a process for a client agent running on an operating system in a virtual machine to output performance and event data received from an agent running on the host operating system to the client operating system on which the client agent is running.

FIG. 5 is a schematic drawing of multiple communication mechanisms implemented to support inter-virtual machine transfer of performance data, in accordance with one embodiment.

FIG. 6 is flowchart illustrating one embodiment of a process for publishing performance data among virtual machines and host, via peer-to-peer mechanisms, a software bus, or a centralized control mechanism with gather and distribute capabilities.

FIG. 7 is a flowchart illustrating one embodiment of a process for displaying memory allocation information to the user and permitting the re-allocation of such allocations.

FIG. 8 shows a flowchart illustrating operations and logic of software agents to support the display and reconfiguration of physical disk allocations among virtual machines.

FIG. 9 is a block schematic drawing of an exemplary architecture employing firmware components to support transfer of data between a host operating system and agents running on virtual machines.

FIG. 10a is a schematic drawing illustrating an implementation of a software-based architecture configured to run on an exemplary platform hardware configuration including a central processing unit coupled to a memory interface and an input/output interface.

FIG. 10b is a schematic drawing illustrating an implementation of a software-based agent architecture configured to run on platform hardware including a multi-core processor.

FIG. 10c is a schematic drawing illustrating an implementation of a firmware-based virtual machine architecture running on platform hardware including a multi-core processor, wherein the architecture includes a firmware-based virtual machine host and associated firmware agents.

FIG. 10d is a schematic drawing illustrating a variation of the architecture of FIG. 10c, wherein one or more of the virtual machine manager and firmware agents is run on a management core of a multi-core processor.

FIG. 11 is a schematic diagram illustrating the various execution phases that are performed in accordance with the extensible firmware interface (EFI) framework.

FIG. 12 is a block schematic diagram illustrating various components of the EFI system table employed by some embodiments of the invention during firmware variable access.

FIG. 13a is a drawing illustrating on embodiment of a unified user interface for display of the relationships among virtual machines and host operating system and performance data for the host system and each virtual machine.

FIG. 13b is an illustration one embodiment of a user interface for viewing virtual machine memory and disk configuration and processor allocation shown for multiple virtual machines.

FIG. 14a is an illustration of one embodiment of a user interface for configuring and re-configuring virtual machine memory allocation.

FIG. 14b is an illustration of one embodiment of a user interface for configuring virtual machine memory allocation.

FIG. 15 is an illustration of one embodiment of a user interface for viewing virtual machine performance data for multiple virtual machines and host from any virtual machine or the host.

FIG. 16 is an illustration of one embodiment of a user interface for viewing the time on multiple virtual machines and modifying the time, date, and use of network protocol time for one or more virtual machines.

FIG. 17 is a drawing illustrating one embodiment of a user interface for viewing virtual machine operating system status and users for multiple virtual machines from any virtual machine or host.

### DETAILED DESCRIPTION

Embodiments of methods, architectures, software/firmware and systems for enabling concurrent administration of host operating systems and virtual machine-hosted operating systems are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

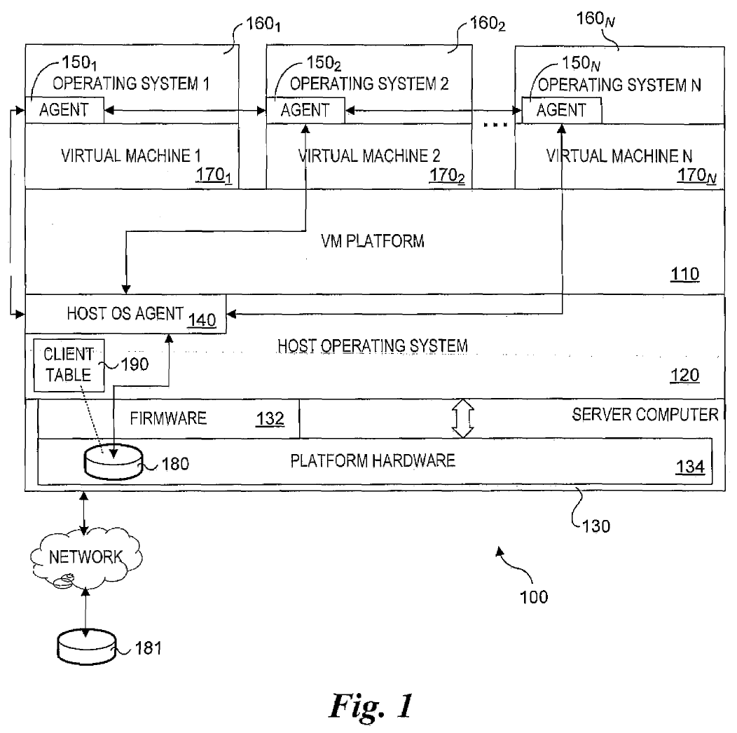

FIG. 1 shows an architecture 100 that supports the transfer of administrative data between a host operating system and one or more operating systems running in virtual machines. Architecture 100 includes a Virtual Machine (VM) platform 110 that runs on top of a host operating system (OS) 120, which runs on a server computer 130 including platform firmware 132 and platform hardware 134. In one embodiment, VM platform 110 comprises VMWare ESX Server, which runs on a LINUX-based host OS 120. In one embodiment, the LINUX-based host OS 120 comprises a RED HAT Enterprise LINUX 3 installation. In one embodiment, server computer 130 comprises an Intel-based platform. It is noted that the foregoing specified software and hardware are merely illustrative, as other versions of software and hardware may be employed to provide similar functionality to that described herein without departing from the scope and spirit of the invention.

A host OS agent 140 is employed to extract various administrative data from host operating system 120 and exposes that information through a plurality of mechanisms to one or more operating systems 160₁₋ₙ running in respective virtual machines 170₁₋ₙ, hosted by VM platform 110. For example the various administrative data may include performance and event data such as available and utilized disk space, memory usage, CPU usage, failed logon attempts, the starting and stopping of processes, and the consumption of resources by individual processes

In one embodiment, host OS agent 140 communicates with another software agent 170₁₋ₙ installed in the virtual machine-hosted operating system 160₁ (running on virtual machine 170₁) to expose administrative data from host operating system 120 via the administrative data interfaces of operating system 160₁. In one embodiment, operating system 160₁ comprises WINDOWS Server 2003. In an alternative embodiment, agent 120 communicates directly with operating system 160₂ to expose administrative data from host operating system 120 to the administrative data interfaces of operating system 160₂.

As further depicted in FIG. 1, a respective agent 150₁₋ₙ may be employed on each of virtual machines 170₁₋ₙ to facilitate operations described herein in a manner similar to agent 170₁₋ₙ. In general, each of agents 150₁₋ₙ may communicate either directly or indirectly with host OS agent 140 via appropriate application program interfaces and the like (not shown in FIG. 1 for clarity and simplicity) or other means described below. In addition, in one embodiment agents 150₁₋ₙ are enabled to communicate various administrative data between themselves in a peer-to-peer manner.

Generally, the various administrative data will be stored via some type of storage mechanism, such as a data structure in memory and/or one or more file system files. The storage mechanism is illustrative herein by various data stores, such as data stores 180 and 181 in FIG. 1. More specifically, data store 180 is illustrative of on-board or local storage means, such as a local disk drive or system memory, while data store 180 is illustrative of a remote storage means, such as a store that is access via a network 185.

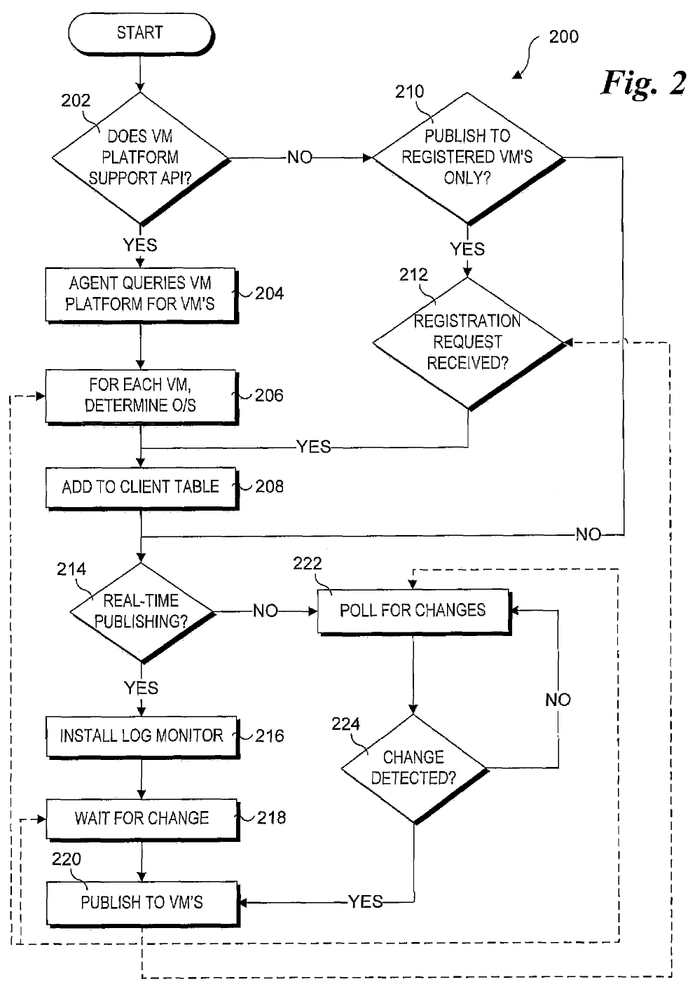

FIG. 2 illustrates one embodiment of a process flow 200 for determining if new administrative data is available on host operating system 120. First, in a decision block 202, the host OS agent 140 determines what virtual machine platform 110 is running on the host operating system 120 and whether that virtual machine platform supports an application programming interface (API) for determining information about the virtual machines 170₁₋ₙ, running on the virtual machine platform. If the virtual machine platform supports such an API, the host OS agent queries the virtual machine platform for a list of virtual machines running on the VM platform, at block 204; then, for each virtual machine, it determines the operating system running on that virtual machine, as shown in block 206. The OS and virtual machine information is then added to a client table 190 of architecture 100 (FIG. 1) in a block 208.

If the virtual machine platform does not support an application programming interface, then the logic proceeds to a decision block 210, wherein the host OS agent determines whether it is configured to publish administrative data only to clients that register with it, or to any recipient. If configured only to support publishing of administrative data to registered virtual machine clients, then the host OS agent waits for a registration request, as depicted by a decision block 212, in a low-priority threaded process that runs and waits for registration requests; when a registration request is received, the client virtual machine is added to client table 190, in block 208. Alternatively, if the software agent is configured to publish its information to any virtual machine client (either in encrypted or unencrypted form) without requiring registration, the host OS agent continues the process at a decision block 214.

Continuing at this decision block, the host OS agent determines its actions based on whether it is configured for real-time publishing or not. If it is, the logic proceeds to blocks 216, 218, and 220, wherein it respectively installs a performance and log monitor, which waits to be notified of changes to system performance, with the changes then being published to the operating systems running in virtual machines 170₁₋ₙ, as applicable. If real-time publishing is not supported, then the host OS agent polls for changes in a block 222. In one embodiment, pooling may be performed at a user-specified Interval by running the df and ps system commands on RED HAT Enterprise LINUX 3, and processing the output of those commands. The host OS agent also checks the recorded timestamp and file size of system logs to determine if changes to those logs have occurred, as depicted by a decision block 224; in response to a detected change, e.g., if a change is detected in memory, CPU or disk usage, or if an important system event has occurred as indicated by a change to a system log file, that information is then published to the operating systems running in the virtual machines 170₁₋ₙ, in block 220. The process repeats itself as more virtual machines register with the host OS agent, decision block 212, and as the host OS agent polls, block 222, or is alerted to changes, block 218, which changes are then published to the virtual machine-hosted operating systems in block 220.

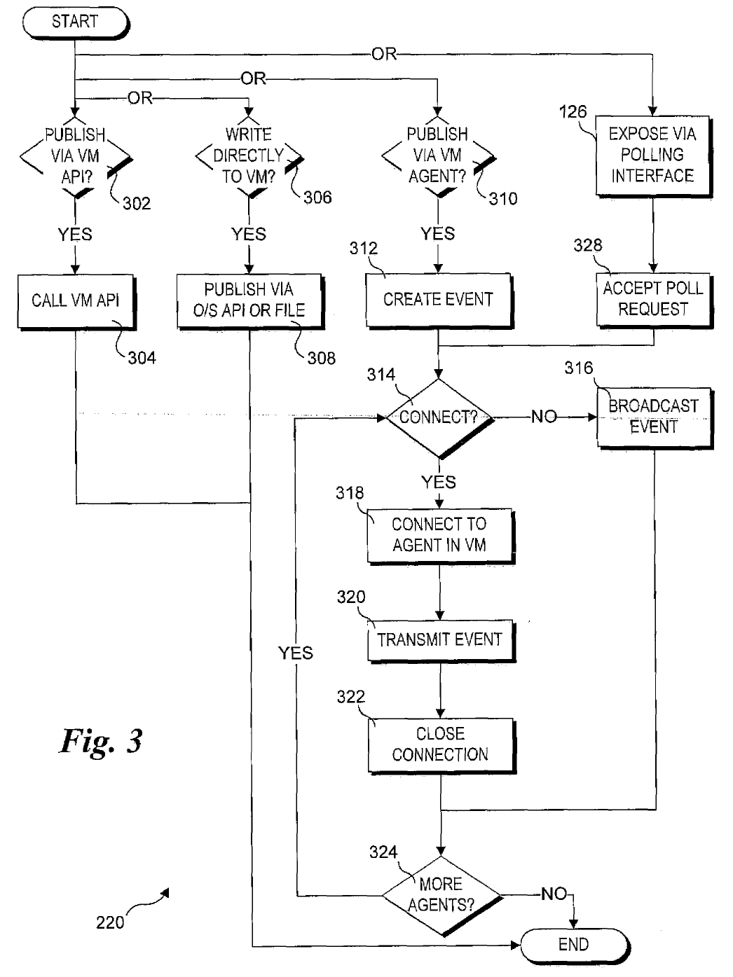

FIG. 3 shows further details of the operations and logic for publishing administrative data to the operating systems running in the virtual machines corresponding to block 220 of FIG. 2. There are a variety of mechanisms a host OS agent may implement to publish administrative data to an operating system running on a virtual machine. For example, if the virtual machine platform supports an (API) for publishing administrative data between itself and virtual machines that it hosts, the host OS agent publishes the new administrative data via the VM platform API, as depicted by decision block 302 and block 304.

If publication via a VM platform API is not supported, the logic proceeds to a decision block 306, wherein the host OS agent determines if it can write directly to the virtual machine using an interface provided by the operating system running in the virtual machine. If it can, then the administrative data is either published via an OS API or written to a file in a block 308. For example, if the operating system in the virtual machine supports publication via an API, such as WINDOWS Server 2003, the virtual machine publishes the administrative data about the host via that API in block 308. As an alternative, if the operating system running in the virtual machine employs file logs for logging administrative data, such as various LINUX implementations (e.g., RED HAT Enterprise LINUX 3), then the host OS agent writes a file directly to the operating system containing performance and event information about the host operating system in block 308.

An additional way to publish performance and event information about the host to the virtual machine clients involves publication of performance and event data to software agents running on the operating systems of the virtual machines. Accordingly, a determination is made in a decision block 310 to determine if this approach is available. Under this approach, the host OS agent first creates a performance event, as shown in a block 312. In one embodiment, the performance or event data contained in the event is formatted using the extensible Markup Language (XML), a text-based format used for descriptions of data. This enables the OS host agent to communicate one or more pieces of performance or event data by describing each piece of data in the XML. In one implementation, the text based XML description is then compressed into a binary format for more efficient transfer.

In a decision block 314, the host OS agent determines whether it should connect to one of the agents running in the virtual machines (which has previously registered with the host OS agent), to communicate new performance or event data to that agent. If no connection is demanded, then the agent broadcasts performance information and changes, as shown in a block 316. This may be accomplished, for example, using the Internet Protocol broadcast or multicast connectionless communication mechanisms. If a connection is demanded, then in a block 318, the software agent on the host connects to an agent in the virtual machine, transmits the event information, block 320, and closes the connection, block 322. It then determines in a decision block 324 whether performance information needs to be communicated to additional client agents (running in respective virtual machines); if so, the process is repeated, as shown by a loop back to decision block 314.

The OS host agent may support an additional communication mechanism, whereby it exposes performance and event data via a polling interface, as depicted by blocks 326 and 328. In one implementation, the host OS agent has a process that runs continuously, awaiting poll requests from agents running in the virtual machines; when poll requests are received, they are accepted in block 328, and the logic flows to decision block 314, with the OS host agent communicating performance data as previously described.

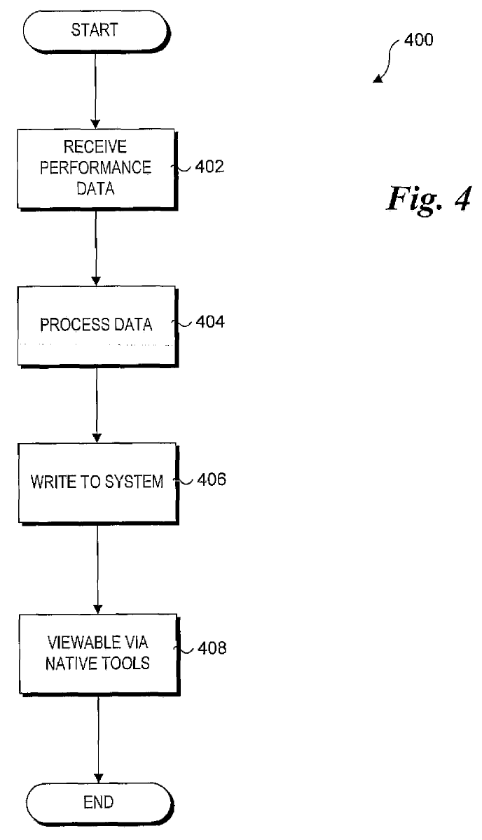

Flowchart 400 in FIG. 4 shows one technique for communicating performance and event data between the host OS agent and a client agent running in an operating system hosted by a virtual machine. In one embodiment, client agent is run on the WINDOWS Server 2003 operating system in a virtual machine hosted by an instance of VMWare ESX Server running on a host running the RED HAT Enterprise LINUX 3 operating system. Accordingly, the client agent receives performance and event data from the software agent running on the host, as shown at block 402. It then processes the data, which may include de-compressing it if it was stored in compressed or binary form and un-encrypting it if it was encrypted. For each piece of performance data, the agent calls an operating system application programming interface to expose that performance data to the operating system. Because the agent has written the performance data received from the host (running a different operating system that that running in the virtual machine) in the native format of the operating system running in the virtual machine, the performance data of the host is now viewable from the native performance and event monitoring tools of the virtual machine operating system, as shown in a block 408.

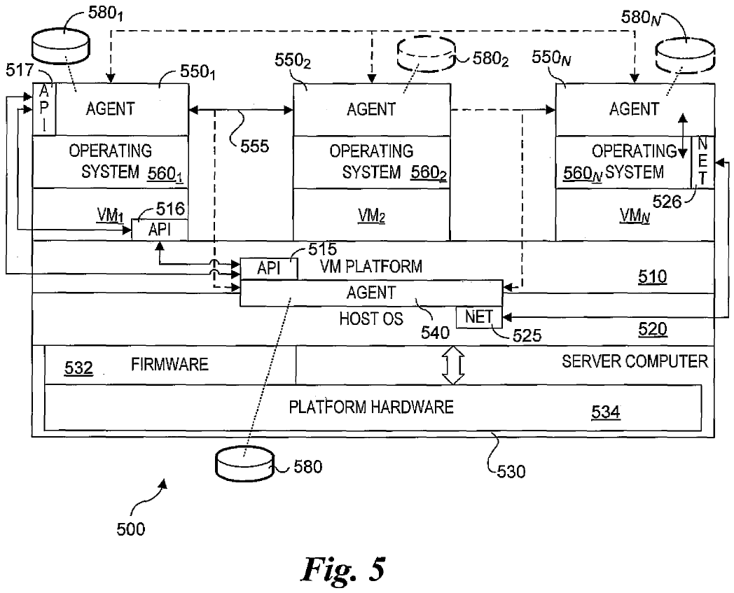

Under architecture 500 of FIG. 5, agents are enabled to communicate with one another through various mechanisms. In further detail, architecture 500 includes a VM platform 510 that is used to host a plurality of virtual machines VM_{1-N}. The VM platform 910 is hosted by a host OS 920 running on server computer 930. Generally, host OS 920 is enabled to access most platform hardware 934 through an interface provided by firmware 932. Meanwhile, depending on the configuration of server computer 930, some of platform hardware 934 may be directly accessed by host OS 920.

In FIG. 5, a software agent 55, running on an operating system 560₁ of virtual machine VM₁ implements multiple communication mechanisms for communicating with other agents, such as an agent 550₂ running on an operating system 560₂ of a virtual machine MV₂, and a host OS agent 540. In one implementation, agent 550₁ implements a peer-to-peer communication mechanism with agent 550₂ running, as depicted by double-headed arrow 555. In another implementation, agent 550₁ acts as the central collector for the performance information from other virtual machines and the host system.

In further detail, communication between agents may be facilitated in one of many ways known to those skilled in the software and communications art. For instance, host OS agent 540 may communicate with a virtual machine via respective APIs 515 and 516 provided by the host OS agent and the VM. In turn, an agent 550 may then communicate with the virtual machine API 516 via an API 517, as illustrated in FIG. 5. Under another embodiment, API 515 may communicate directly with API 517. Under yet another scheme, operating system-level communications are employed to enable communication between the host OS and a VM-hosted OS. For example, respective network OS components 525 and 526 (e.g., network stacks) may facilitate communications using a network protocol, such as TCP/IP or UDP. In turn, the respective agents may communicate with their respective OS hosts via an API or the like or some other OS-to-application communication scheme.

As further shown in FIG. 5, in one embodiment various performance, configuration, and event data may be stored in a data store 580 accessed via host OS agent 540. Optionally, each of agents 550₁₋ₙ may manage and/or be provided access to a replicated instance of these data, as depicted by data stores 550₁₋ₙ. In general, the VM-hosted agents may employ respective portions of system memory allocated to their respective VM and/or local or remote disk storage space allocated to their respective VM.

In accordance with further aspects of inter-agent communication, various techniques may be employed to support peer-to-peer, software- and hardware-bus-based, and control-based transfer of administrative data among the host and virtual machines. In one embodiment of a peer-to-peer implementation the agents communicate with each other in an ad hoc manner, in which all of the agents are equal to each other. Agents talk directly to each other to send or receive performance data. Under one embodiment of a bus architecture, a common subsystem is implemented that transfers data between the agents. Each agent can join the bus to communicate data to other agents. In one software implementation, the bus comprises a set of ‘C’ functions that allow agents to perform a variety of operations. An agent can execute a remote function on another virtual machine via an agent on another virtual machine or the host. For example, an agent can execute a remote command to get CPU usage or disk space free data, or to set memory to disk swap allocation, regardless of the remote operating system. The bus supports synchronous and asynchronous operations; when used in asynchronous mode, callbacks are supported to return status to the calling agent once an operating is complete. The bus also supports common updates, such that a data value changed in one agent can be distributed by the bus to all other agents (whereas, in a peer to peer implementation, one agent would need to communicate to several other agents, which might then communicate with other agents, and so on.) In another instantiation, a hardware bus is implemented, which supports similar functions, but in hardware. In the control-based implementation, one agent acts as the master (e.g., a host OS agent), acting as the central control for retrieval and distribution of data.

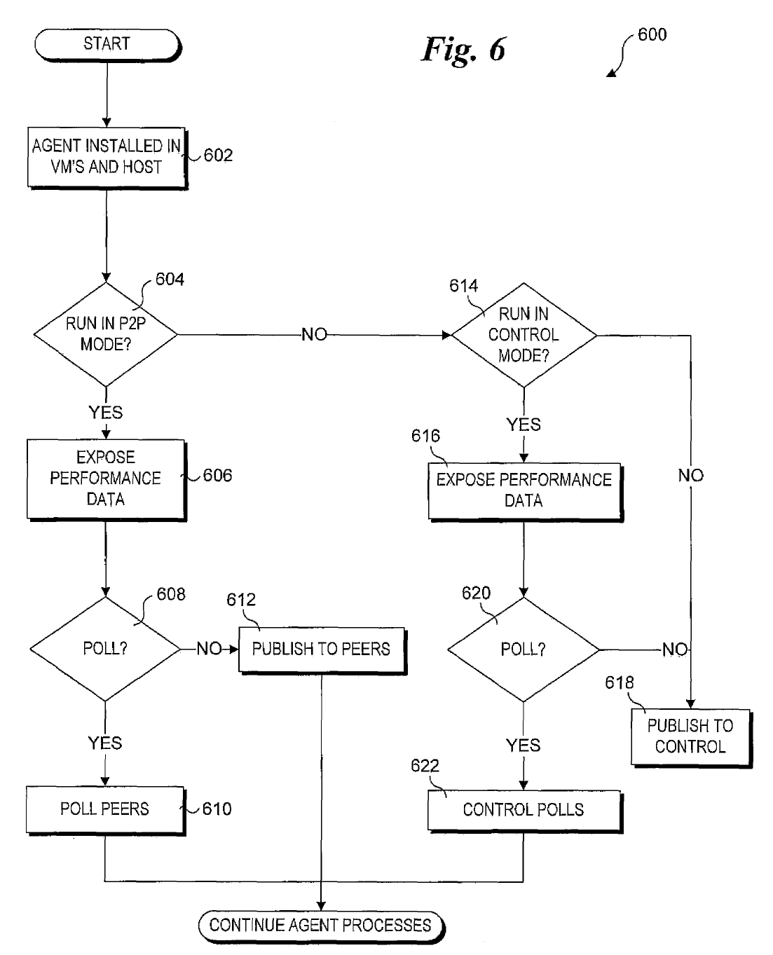

FIG. 6 shows a flowchart 600 illustrating operations and logic associated with the architecture of FIG. 5. In a block 602, software agents are installed on the operating system running on a virtual machine and on the host operating. If the agent is configured to run in peer-to-peer (P2P) mode, as determined at a decision block 604, then the agents expose performance and log events, as previously described, in a block 606. Additionally, the agent may also announce its presence at a user-configurable interval, so that other agents know that that agent is operating. If the agent is configured to poll other peers, decision block 608, it requests information from other peers in a block 610 using a connection-less UDP or connection-based TCP/IP interface to request performance data from peer agents. If the agent is configured not to poll, then it publishes performance data about the system on which it is running via a UDP or TCP/IP mechanism to other peers, as depicted in a block 612. In this way, the agent receives performance data from other peers and exposes performance data to those other peers.

If an agent is not configured to run in P2P mode, the agent determines whether it is configured to run in control mode in a decision block 614. If yes, then the agent serves as the central collection and publishing point for the performance data for the host and the virtual machines. In block 616, the agent exposes event data from its own system and from any client agents that have connected to it and provided it with performance data. If the agent is not running in control mode (meaning, it is only publishing data about its own system, not acting as a central collection point), then it publishes data to the control agent via communication mechanisms previously described, as shown in a block 618. Alternatively, if the software agent is configured in polling mode, a determined at a decision block 620, the agent configured as the control polls the other agents for performance information, as shown in a block 622.

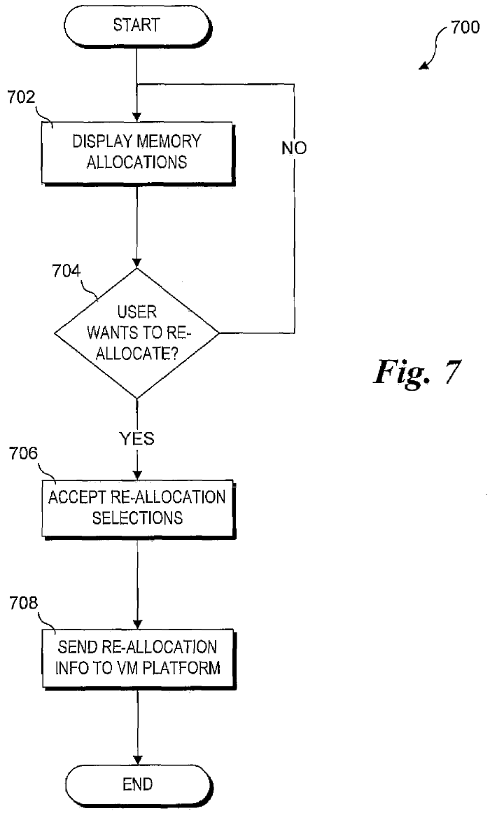

FIG. 7 shows a flowchart 700 illustrating one embodiment of operations and logic associated with the display of memory allocations among the plurality of virtual machines and the re-configuration of such memory allocations using, for example, software agents 140 and 150 of architecture 100 (FIG. 1). In a block 702, software agents 140 and 150 display, through a graphical user interface, how physical computer memory of server computer 130 is allocated to one or more virtual machines 170₁₋ₙ. As depicted in a decision block 704, one of the agents receives an indication from the user via the graphical user interface that the user desires to re-allocate physical memory across the virtual machines. In response, in a block 706 the agent receives and accepts the re-allocation selections for the virtual machines, and in a block 708 communicates the re-allocation selection to virtual machine platform 110 via an API supported by virtual machine platform 110.

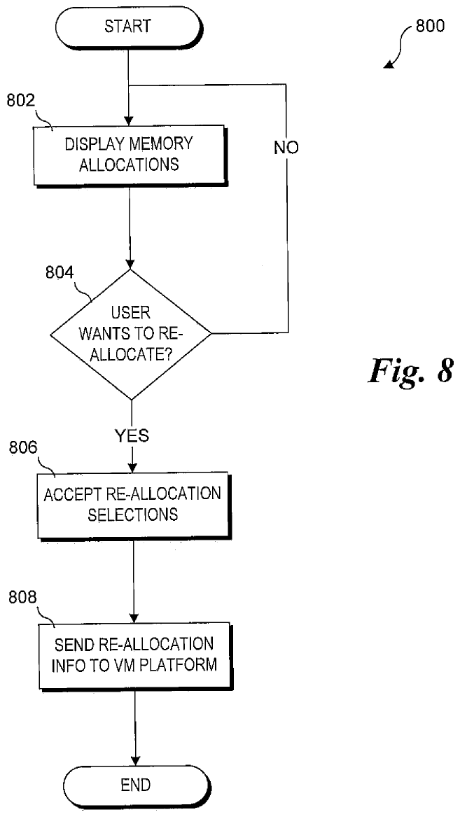

FIG. 8 shows a flowchart 800 illustrating operations and logic performed by one embodiment of software agents 140 and 150 to further support the display of physical disk allocations among the plurality of virtual machines and the re-configuration of such allocations. In a block 802, software agents 140 and 150 display, through a graphical user interface, the allocation of physical disk space of server computer 130 to one or more of virtual machines 170₁₋ₙ. In a decision block 804, one of the software agents receives an indication from the user via the graphical user interface that the user desires to re-allocate physical disk space among the virtual machines. In response, the agent receives and accepts the re-allocation selections for one or more of the virtual machines in a block 806, and in a block 808 communicates the re-allocation selection to virtual machine platform 110, via an API supported by virtual machine platform 110.

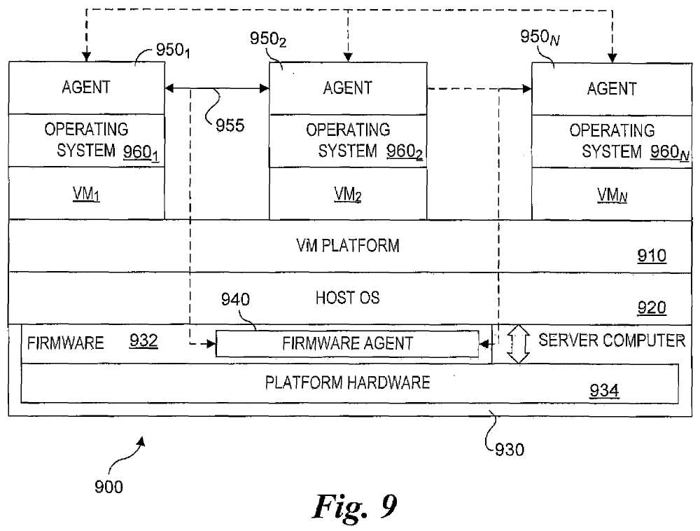

In addition to using various forms of software agents for enabling communication of performance and event data between operating systems, all or a portion of similar functionality may be supported via firmware-based components. For example, FIG. 9 shows an architecture 900 that is similar to architecture 500 of FIG. 5 that employs a firmware agent 940 in place of host OS (software) agent 540.

In general, components in FIGS. 5 and 9 sharing the last two digits perform similar functions. In further detail, architecture 900 includes a VM platform 910 that is used to host a plurality of virtual machines VM_{1-N}. The VM platform 910 is hosted by a host OS 920 running on server computer 930. Generally, as with architecture 500, host OS 920 is enabled to access most platform hardware 934 through an interface provided by firmware 932, while some of platform hardware 934 may be directly accessed by host OS 920.

As before, the various agents 950_{1-N} are enabled to communicate in a peer-to-peer manner. Additionally, each of agents 950_{1-N} are enabled to communicate with firmware agent 940 through a firmware API discussed below in further detail. Host OS 920 may also communicate with firmware agent 940 via the firmware API.

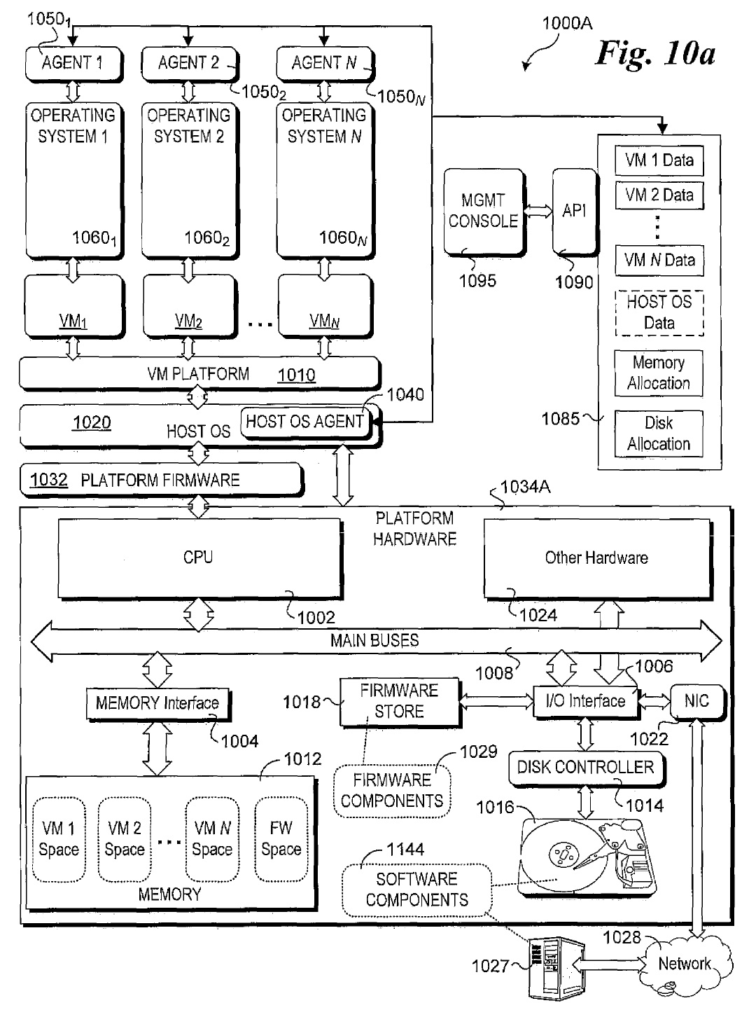

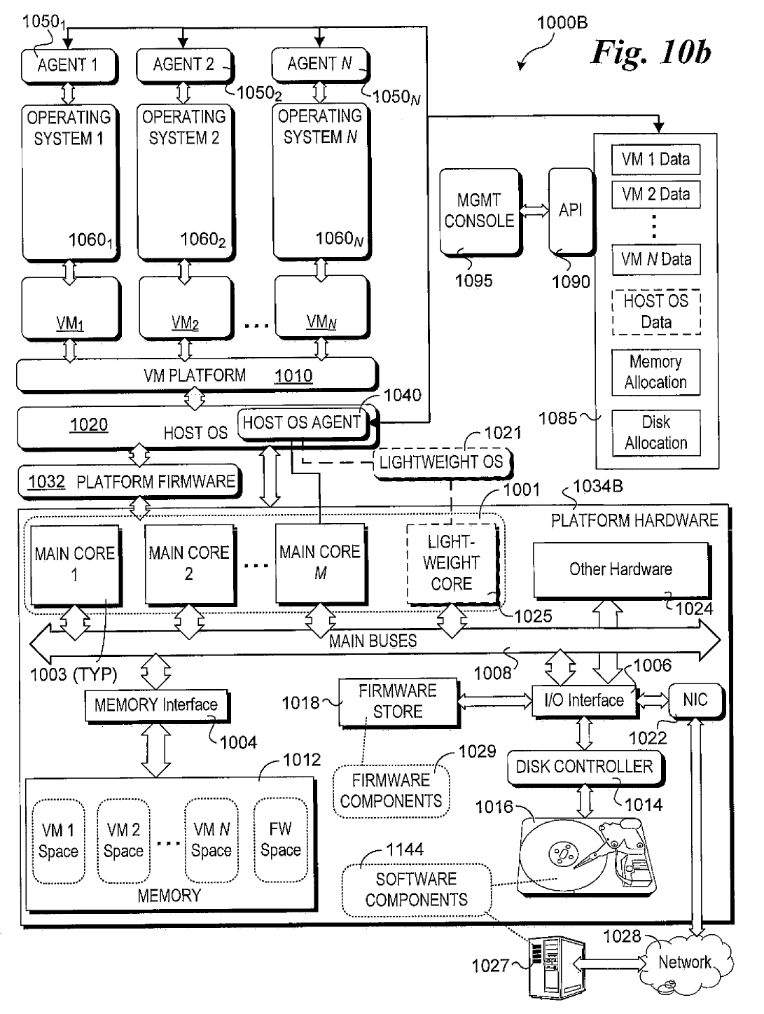

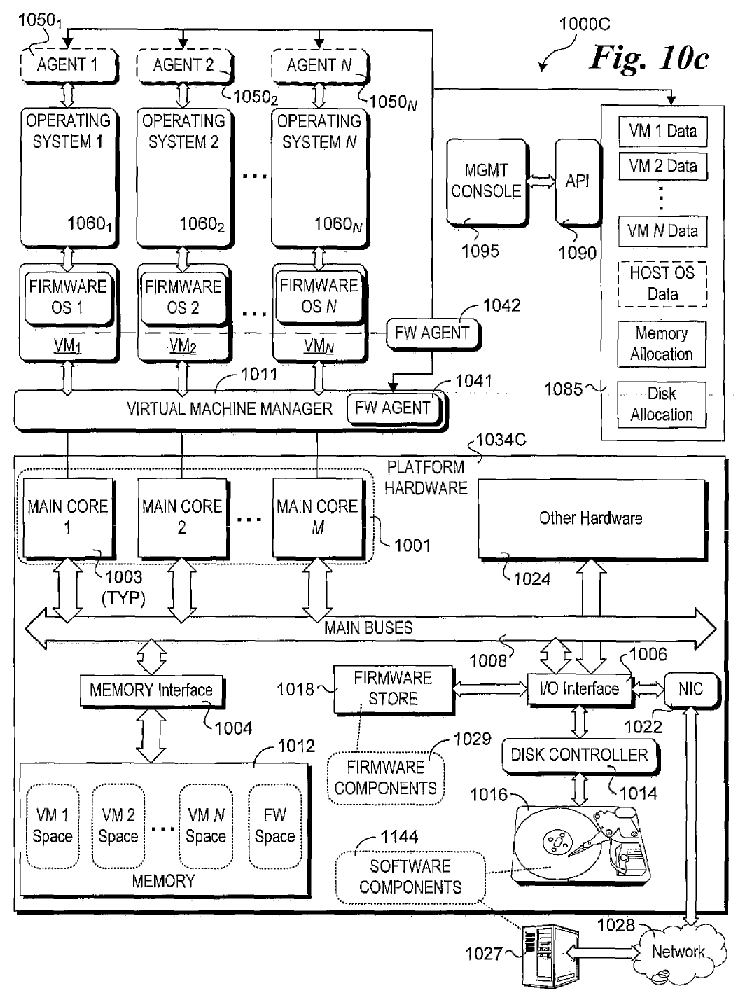

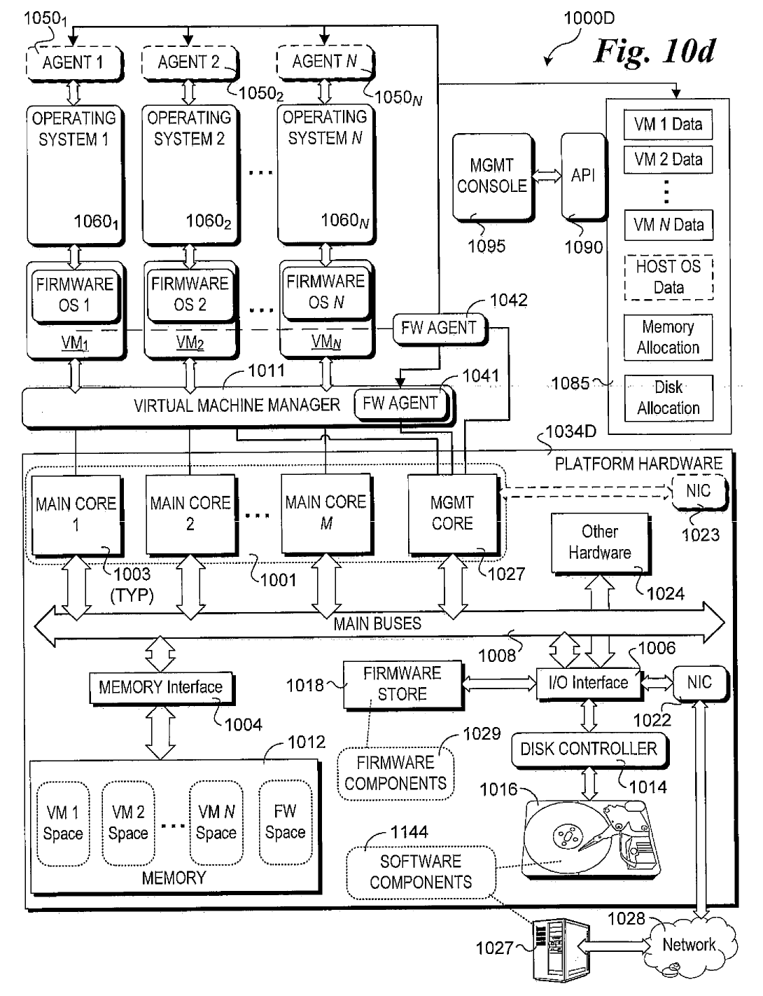

Further details of various software and firmware implementations are shown in FIGS. 10a and 10b, wherein like-referenced components perform similar functions. Under architecture 1000A of FIG. 10a, a VM platform 1010 hosts virtual machines VM1-N on which operating systems 1060_{1-N} are run. Communications with each of these operating systems is supported via respective agents 1050_{1-N}. A host OS agent 1040 supports communication with host OS 1020. A firmware layer 1032 is disposed between host OS 1020 and platform hardware 1034.

As discussed above, the techniques disclosed herein enable various data in events corresponding to the operation of the various operating systems to be made available in a manner that only requires familiarity with a single operating system. For example, the agents can publish or otherwise make available performance and event data in a manner consistent with a first type of operating system that is familiar to IT professional, while at the same time the various operating systems that are deployed may include operating systems that are unfamiliar to the IT professional. For simplicity and clarity, an exemplary set of such data is shown as published data 1085, which includes performance and event data for each of operating systems 1060_{1-N}, as well as host OS 1020,

The configuration, performance and event data may be accessed via various mechanisms, depending on the particular implementation. For example, an API 1090 may be provided to provide a programmatic interface to published data 1085. In one embodiment, API 1090 supports native calls associated with a management console 1095 or the like, such as a WINDOWS management console or a LINUX management console. Thus, the management counsel may use native (to the associated operating system) calls to obtain published data 1085. API 1090 also supports native calls to reconfigure various platform components, such as memory and disk allocations. In another embodiment, API 1090 provides an XML-based interface, supporting an interface with published data 1085 via XML-formatted requests and posts.

FIG. 10a further shows an exemplary platform hardware configuration 1034 including a central processing unit (CPU) 1002 coupled to a memory interface 1004 and an input/output (I/O) interface 1006 via main buses 1008. For example, under the well-known Intel Northbridge/Southbridge architecture, memory interface 1004 may be implemented in a Northbridge chipset component (e.g., memory controller hub (MCH)), while I/O interface 1006 may be implemented in a Southbridge component (e.g., I/O controller hub (ICH)). System memory 1012 may be accessed via memory interface 1004.

In general, CPU 1002 may comprise a single core processor or a multi-core processor. Under architecture 1000A, operations for a multi-core processor are not segregated to a respective virtual machine. Rather, the virtual machines are run as threads running as tasks on the multiple processor cores.

I/O interface 1006 is employed to access several components, including a disk controller 1014, which in turn is used to access one or more disk drives 1016. I/O interface 1006 is also used to access a firmware store 1018 (e.g., a ROM or non-volatile memory) and a network interface controller (NIC) 1022. In addition to the hardware components shown, various other hardware 1024 may be accessed the appropriate hardware interfaces, including I/O interface 1006.

In general, the various software components discussed herein, including operating systems and software agents collectively illustrated as software components 1026, will typically be stored on a disk drive 1016 and loaded into system memory 1012 during system boot operations. Optionally, all or a portion of software components 1026 may be loaded from a server 1027 via a network 1028. Meanwhile, the various firmware components discussed herein, including platform firmware 1032 and firmware-based agents (as applicable) generally depicted as firmware components 1029, will generally be loaded from firmware store 1018 during system boot and loaded into a firmware space in system memory 1012.

Under a typical system boot for architecture 1000A, platform firmware 1032 will be loaded and configured in system memory 1012, followed by booting the host OS 1020. Subsequently, VM platform 1010, which may generally comprise an application running on host OS 1020, will be launched. VM platform 1010 can generally be configured to launch one or more virtual machines VM_{1-N}, each of which will be configured to use various portions (i.e., address spaces) of system memory 1012. In turn, each virtual machine VM_{1-N} may be employed to host a respective operating system 1060_{1-N}.

During run-time operations, the host OS agent 1040 and agents 1050_{1-N} are employed to publish various configuration, performance, and event data and enable reconfiguration of various system resources, such as system memory 1012 and disk drive(s) 1016. Generally, the virtual machines provide abstractions (in combination with VM platform 1010) between their hosted operating system and the underlying platform hardware 1034. From the viewpoint of each hosted operating system, that operating system “owns” the entire platform, and is unaware of the existence of other operating systems running on virtual machines. In reality, each operating system merely as access to only those resource spaces allocated to it.

Architecture 1000B of FIG. 10b includes platform hardware 1034B employing a multi-core processor 1001 having 2 or more (i.e., M) main processing cores 1003. In the illustrated embodiment, processor 1001 further includes an optional lightweight core 1025. Under various embodiments, one or more of host OS 1020, host OS agent 1040, and agents 1050_{1-N} may be run on a selected main core and/or lightweight core 1025 (if present). Under one embodiment, a lightweight operating system 1021 may run on lightweight core 1025 and host one or more of host OS agent 1040 and agents 1050_{1-N}.

Architecture 1000C of FIG. 10c illustrates one embodiment of a firmware-based implementation running on a multi-core processor, wherein each virtual machine instances is associated with a respective main processor core. In further detail, architecture 1000C includes a firmware-based virtual machine manager (VMM) 1011 that is employed to manage firmware-based virtual machines VM_{1-N}. Each virtual machine VM_{1-N} also provides a firmware instance via which a respective operating system instance accesses platform hardware 1034C. A given firmware instance may be OS-specific (i.e., designed for hosting a particular operating system, or may be “generic” to a particular platform architecture. For example while WINDOWS operating systems are generally designed to run on Intel-based processors (and instruction set equivalents such as AMD processors), various versions of LINUX and UNIX™ software are designed to run on other types of processor architecture in addition to Intel-based processors. Accordingly, the OS-specific firmware may be configured to “abstract” a particular platform architecture to its associated operating system.

In general, a “host” firmware agent may be deployed as part of virtual machine manager 1011, or as a component of a virtual machine VM_{1-N}, as respectively depicted by firmware agents 1041 and 1042. Meanwhile, architecture 1000C may employ software agents 1050_{1-N} in a manner similar to architecture 1000A, or may employ firmware agents in the host virtual machines VM_{1-N} in lieu of the software agents.

Platform hardware 1034C includes a multi-core processor 1001 having 2 or more (i.e., M) main processing cores 1003. In the illustrated embodiment, VMM 1011 is configured to allocate processing resources for each of cores 1003 to a respective virtual machine VM_{1-N}. Depending on the particular multi-core architecture, system memory 1012 may have fixed mapping to the processor cores, or a shared interface may be employed in which address spaces in system memory 1012 are reconfigurable to enable different-size portions of the system memory to be allocated to the main processing cores.

In general, VMM 1011 will run on one of main processing cores 1003. For example, in one embodiment VMM 1011 is run on the first main core. Typically, VMM 1011 will be loaded into system memory during system initialization, as well as the various virtual machine instances. Various details of an exemplary technique for building a firmware framework are discussed below.

Another architecture 1000D for implementing a firmware-based scheme is shown in FIG. 10d. Architecture 100D is substantially similar to architecture 1000C of FIG. 10c, and further includes a management core 1027 and an optional NIC 1023. In general, processor 1001 may include one or more processing cores 1003. Meanwhile, a separate management core is provided to facilitate various operations, such as management functions.

Under one embodiment, one or more of virtual machine manager 1011, firmware agent 1041, and firmware agent 1042 is hosted by (i.e., run on) management core 1027. By providing a separate core for hosting these firmware components, the components may be run during operating system run-time without affecting the operation of the various operating systems. Moreover, the firmware components may be run in a manner that is transparent to the operating systems. In general, these firmware components may be run on a continuous or intermittent basis. In one embodiment, a periodic timer is implemented to periodically activate selected firmware components to facilitate various agent operations discussed herein.

In order to support a firmware-based implementation, there needs to be some mechanism to enable communication between software (e.g., operating systems and software agents, if employed) and firmware components (e.g., the VMM layer and firmware agents). Fortunately, today's firmware architectures include provisions for extending BIOS functionality beyond that provided by the BIOS code stored in a platform's BIOS device (e.g., flash memory). More particularly, the Extensible Firmware Interface (EFI) (specifications and examples of which may be found at http://developer.intel.com/technology/efi) is a public industry specification that describes an abstract programmatic interface between platform firmware and shrink-wrap operation systems or other custom application environments. The EFI framework include provisions for extending BIOS functionality beyond that provided by the BIOS code stored in a platform's BIOS device (e.g., flash memory). EFI enables firmware, in the form of firmware modules and drivers, to be loaded from a variety of different resources, including primary and secondary flash devices, option ROMs, various persistent storage devices (e.g., hard disks, CD ROMs, etc.), and even over computer networks.

Among many features, EFI provides an abstraction for storing persistent values in the platform firmware known as “variables.” Variables are defined as key/value pairs that consist of identifying information plus attributes (the key) and arbitrary data (the value). Variables are intended for use as a means to store data that is passed between the EFI environment implemented in the platform and EFI OS loaders and other applications that run in the EFI environment. Moreover, the firmware variables may be accessed during run-time operations using appropriate API's.

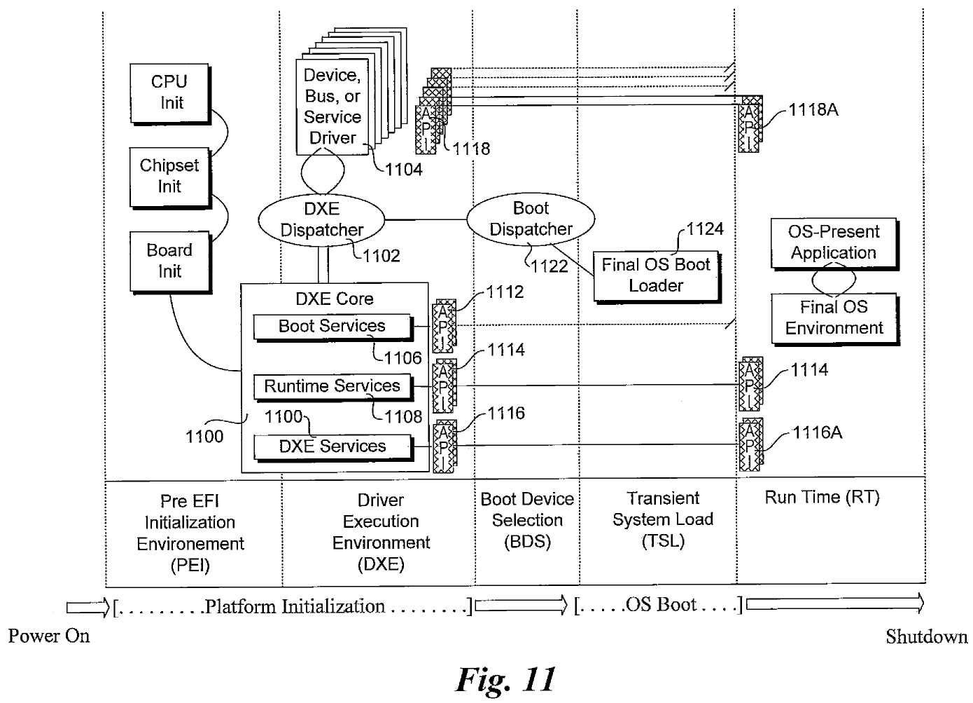

In accordance with one embodiment, a software-to-firmware communication framework is implemented via facilities provided by EFI. FIG. 11 shows an event sequence/architecture diagram used to illustrate operations performed by a platform under an EFI-compliant framework in response to a cold boot (e.g., a power off/on reset). The process is logically divided into several phases, including a pre-EFI Initialization Environment (PEI) phase, a Driver Execution Environment (DXE) phase, a Boot Device Selection (BDS) phase, a Transient System Load (TSL) phase, and an operating system runtime (RT) phase. The phases build upon one another to provide an appropriate run-time environment for the OS and platform.

The PEI phase provides a standardized method of loading and invoking specific initial configuration routines for the processor (CPU), chipset, and motherboard. The PEI phase is responsible for initializing enough of the system to provide a stable base for the follow on phases. Initialization of the platforms core components, including the CPU, chipset and main board (i.e., motherboard) is performed during the PEI phase. This phase is also referred to as the “early initialization” phase. Typical operations performed during this phase include the POST (power-on self test) operations, and discovery of platform resources. In particular, the PEI phase discovers memory and prepares a resource map that is handed off to the DXE phase. The state of the system at the end of the PEI phase is passed to the DXE phase through a list of position independent data structures called Hand Off Blocks (HOBs).

The DXE phase is the phase during which most of the system initialization is performed. The DXE phase is facilitated by several components, including the DXE core 1100, the DXE dispatcher 1102, and a set of DXE drivers 1104. The DXE core 1100 produces a set of Boot Services 1106, Runtime Services 1108, and DXE Services 1110. The DXE dispatcher 1102 is responsible for discovering and executing DXE drivers 1104 in the correct order. The DXE drivers 1104 are responsible for initializing the processor, chipset, and platform components as well as providing software abstractions for console and boot devices. These components work together to initialize the platform and provide the services required to boot an operating system. The DXE and the Boot Device Selection phases work together to establish consoles and attempt the booting of operating systems. The DXE phase is terminated when an operating system successfully begins its boot process (i.e., the BDS phase starts). Only the runtime services and selected DXE services provided by the DXE core and selected services provided by runtime DXE drivers are allowed to persist into the OS runtime environment. The result of DXE is the presentation of a fully formed EFI interface.

The DXE core is designed to be completely portable with no CPU, chipset, or platform dependencies. This is accomplished by designing in several features. First, the DXE core only depends upon the HOB list for its initial state. This means that the DXE core does not depend on any services from a previous phase, so all the prior phases can be unloaded once the HOB list is passed to the DXE core. Second, the DXE core does not contain any hard coded addresses. This means that the DXE core can be loaded anywhere in physical memory, and it can function correctly no matter where physical memory or where Firmware segments are located in the processor's physical address space. Third, the DXE core does not contain any CPU-specific, chipset specific, or platform specific information. Instead, the DXE core is abstracted from the system hardware through a set of architectural protocol interfaces. These architectural protocol interfaces are produced by DXE drivers 104, which are invoked by DXE Dispatcher 1102.

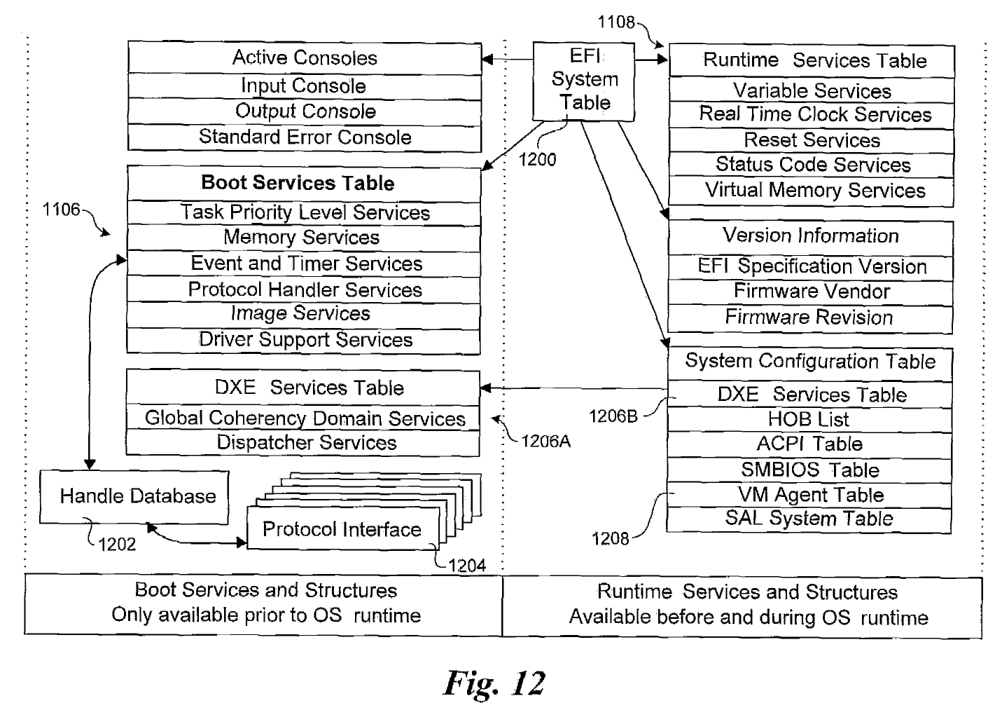

The DXE core produces an EFI System Table 1200 and its associated set of Boot Services 1106 and Runtime Services 1108, as shown in FIG. 12. The DXE Core also maintains a handle database 1202. The handle database comprises a list of one or more handles, wherein a handle is a list of one or more unique protocol GUIDs (Globally Unique Identifiers) that map to respective protocols 1204. A protocol is a software abstraction for a set of services. Some protocols abstract I/O devices, and other protocols abstract a common set of system services. A protocol typically contains a set of APIs and some number of data fields. Every protocol is named by a GUID, and the DXE Core produces services that allow protocols to be registered in the handle database. As the DXE Dispatcher executes DXE drivers, additional protocols will be added to the handle database including the architectural protocols used to abstract the DXE Core from platform specific details.

The Boot Services comprise a set of services that are used during the DXE and BDS phases. Among others, these services include Memory Services, Protocol Handler Services, and Driver Support Services: Memory Services provide services to allocate and free memory pages and allocate and free the memory pool on byte boundaries. It also provides a service to retrieve a map of all the current physical memory usage in the platform. Protocol Handler Services provides services to add and remove handles from the handle database. It also provides services to add and remove protocols from the handles in the handle database. Addition services are available that allow any component to lookup handles in the handle database, and open and close protocols in the handle database. Support Services provides services to connect and disconnect drivers to devices in the platform. These services are used by the BDS phase to either connect all drivers to all devices, or to connect only the minimum number of drivers to devices required to establish the consoles and boot an operating system (i.e., for supporting a fast boot mechanism).

In contrast to Boot Services, Runtime Services are available both during pre-boot and OS runtime operations. One of the Runtime Services that is leveraged by embodiments disclosed herein is the Variable Services. As described in further detail below, the Variable Services provide services to lookup, add, and remove environmental variables from both volatile and non-volatile storage. As used herein, the Variable Services is termed “generic” since it is independent of any system component for which firmware is updated by embodiments of the invention.

As shown in FIG. 12, The DXE Services Table includes data corresponding to a first set of DXE services 1206A that are available during pre-boot only, and a second set of DXE services 1206B that are available during both pre-boot and OS runtime. The pre-boot only services include Global Coherency Domain Services, which provide services to manage I/O resources, memory mapped I/O resources, and system memory resources in the platform. Also included are DXE Dispatcher Services, which provide services to manage DXE drivers that are being dispatched by the DXE dispatcher.

The services offered by each of Boot Services 1106, Runtime Services 1108, and DXE services 1110 are accessed via respective sets of API's 1112, 1114, and 1116. The API's provide an abstracted interface that enables subsequently loaded components to leverage selected services provided by the DXE Core.

After DXE Core 1100 is initialized, control is handed to DXE Dispatcher 1102. The DXE Dispatcher is responsible for loading and invoking DXE drivers found in firmware volumes, which correspond to the logical storage units from which firmware is loaded under the EFI framework. The DXE dispatcher searches for drivers in the firmware volumes described by the HOB List. As execution continues, other firmware volumes might be located. When they are, the dispatcher searches them for drivers as well.

There are two subclasses of DXE drivers. The first subclass includes DXE drivers that execute very early in the DXE phase. The execution order of these DXE drivers depends on the presence and contents of an a priori file and the evaluation of dependency expressions. These early DXE drivers will typically contain processor, chipset, and platform initialization code. These early drivers will also typically produce the architectural protocols that are required for the DXE core to produce its full complement of Boot Services and Runtime Services.

The second class of DXE drivers are those that comply with the EFI 1.10 Driver Model. These drivers do not perform any hardware initialization when they are executed by the DXE dispatcher. Instead, they register a Driver Binding Protocol interface in the handle database. The set of Driver Binding Protocols are used by the BDS phase to connect the drivers to the devices required to establish consoles and provide access to boot devices. The DXE Drivers that comply with the EFI 1.10 Driver Model ultimately provide software abstractions for console devices and boot devices when they are explicitly asked to do so.

Any DXE driver may consume the Boot Services and Runtime Services to perform their functions. However, the early DXE drivers need to be aware that not all of these services may be available when they execute because all of the architectural protocols might not have been registered yet. DXE drivers must use dependency expressions to guarantee that the services and protocol interfaces they require are available before they are executed.

The DXE drivers that comply with the EFI 1.10 Driver Model do not need to be concerned with this possibility. These drivers simply register the Driver Binding Protocol in the handle database when they are executed. This operation can be performed without the use of any architectural protocols. In connection with registration of the Driver Binding Protocols, a DXE driver may “publish” an API by using the InstallConfigurationTable function. This published drivers are depicted by API's 1118. Under EFI, publication of an API exposes the API for access by other firmware components. The API's provide interfaces for the Device, Bus, or Service to which the DXE driver corresponds during their respective lifetimes.

The BDS architectural protocol executes during the BDS phase. The BDS architectural protocol locates and loads various applications that execute in the pre-boot services environment. Such applications might represent a traditional OS boot loader, or extended services that might run instead of, or prior to loading the final OS. Such extended pre-boot services might include setup configuration, extended diagnostics, flash update support, OEM value-adds, or the OS boot code. A Boot Dispatcher 1120 is used during the BDS phase to enable selection of a Boot target, e.g., an OS to be booted by the system.

During the TSL phase, a final OS Boot loader 1122 is run to load the selected OS. Once the OS has been loaded, there is no further need for the Boot Services 1106, and for many of the services provided in connection with DXE drivers 1104 via API's 1118, as well as DXE Services 1206A. Accordingly, these reduced sets of API's that may be accessed during OS runtime are depicted as API's 1116A, and 1118A in FIG. 11.

As shown in FIG. 1 the Variable Services persist into OS runtime. As such, the Variable Services API is exposed to the operating system, thereby enabling variable data to be added, modified, and deleted by operating system actions during OS runtime, in addition to firmware actions during the pre-boot operations. Typically, variable data are stored in the system's boot firmware device (BFD). In modern computer systems, BFDs will usually comprise a rewritable non-volatile memory component, such as, but not limited to, a flash device or EEPROM chip. As used herein, these devices are termed “non-volatile (NV) rewritable memory devices.” In general, NV rewritable memory devices pertain to any device that can store data in a non-volatile manner (i.e., maintain (persist) data when the computer system is not operating), and provides both read and write access to the data. Thus, all or a portion of firmware stored on an NV rewritable memory device may be updated by rewriting data to appropriate memory ranges defined for the device.

Accordingly, a portion of the BFD's (or an auxiliary firmware storage device's) memory space may be reserved for storing persistent data, including variable data. In the case of flash devices and the like, this portion of memory is referred to as “NVRAM.” NVRAM behaves in a manner similar to conventional random access memory, except that under flash storage schemes individual bits may only be toggled in one direction. As a result, the only way to reset a toggled bit is to “erase” groups of bits on a block-wise basis. In general, all or a portion of NVRAM may be used for storing variable data; this portion is referred to as the variable repository.

As discussed above, under EFI, variables are defined as key/value pairs that consist of identifying information plus attributes (the key) and arbitrary data (the value). These key/value pairs may be stored in and accessed from NVRAM via the Variable Services. There are three variable service functions: GetVariable, GetNextVariableName, and SetVariable. GetVariable returns the value of a variable. GetNextVariableName enumerates the current variable names. SetVariable sets the value of a variable. Each of the GetVariable and SetVariable functions employs five parameters: VariableName, VendorGuid (a unique identifier for the vendor), Attributes (via an attribute mask), DataSize, and Data. The Data parameter identifies a buffer (via a memory address) to write or read the data contents of the variable from. The VariableName, VendorGuid parameters enable variables corresponding to a particular system component (e.g., add-in card) to be easily identified, and enables multiple variables to be attached to the same component.

Under a database context, the variable data are stored as 2-tuples <Mᵢ, Bᵢ>, wherein the data bytes (B) are often associated with some attribute information/metadata (M) prior to programming the flash device. Metadata M is implementation specific. It may include information such as “deleted”, etc., in order to allow for garbage collection of the store at various times during the life of the variable repository. Metadata M is not exposed through the Variable Services API but is just used internally to manage the store.

In accordance with aspects of some embodiments of the invention, the foregoing variable data storage and access scheme is augmented in a manner that supports access to and storage of configuration, performance, and event data. In general, the associated variable data may be stored in non-volatile memory or may be stored in system memory. Moreover, in some embodiments, these data may be written to a pre-allocated partition on a disk drive that is configured to be hidden to the operating systems hosted by the virtual machines running on the platform. As a result, these data may be accessed in the event of an operating system crash without need for operating system file system support.

Under firmware-based embodiments that do not employ separate processing facilities for handling run-time firmware separate from run-time software (e.g., that do not employ a management core or the like), there is a need for a mechanism to “switch” the processing mode to jump from processing software to processing firmware, and back to processing the software. One mechanisms for performing these functions in some Intel processors employs the System Management Mode (SMM) (for Intel 32-bit microprocessors, i.e., IA-32 processors), or the native mode of an Itanium-based processor with a Processor Management Interrupt (PMI) signal activation. In general, the state of execution of code in IA32 SMM is initiated by a System Management Interrupt (SMI) signal and that in Itanium™ processors is initiated by a PMI signal activation; for simplicity, these are generally referred to as SMM herein.

Details for one mechanism for implementing an extensible SMM framework that may be employed by embodiments of the invention are disclosed in U.S. Pat. No. 6,978,018 (SMM Loader and Execution Mechanism for Component Software for Multiple Architectures), which is incorporated by reference herein in its entirety. The mechanism allows for multiple drivers, possibly written by different parties, to be installed for SMM operation. An agent that registers the drivers runs in the EFI (Extensible Firmware Interface) boot-services mode (i.e., the mode prior to operating system launch) and is composed of a CPU-specific component that binds the drivers and a platform component that abstracts chipset control of the xMI (PMI or SMI) signals. The API's (application program interfaces) providing these sets of functionality are referred to as the SMM Base and SMM Access Protocol, respectively. These API's enable run-time software to call SMM facilities during run-time operations, causing one or more appropriate event handlers to be loaded in executed in a manner transparent to the run-time software. Such handlers can generally be employed for supporting firmware-based agent operations in accordance with some of the embodiments disclosed herein.

In accordance with further aspects of some embodiments, user interfaces are provided to enable administrators and the like to manage the operation of the various operating systems running on the platform, including both host operating systems and the operating systems running on software- and/or firmware-based virtual machine platforms. In some embodiments a unified user interface (e.g., unified console) is provided to enable management of the operating systems from a single viewpoint, providing operating system information such as resource allocation and consumption, performance measures, event data, etc. Moreover, the unified user interface, in alternative embodiments, may be accessed from a host operating system or one of the virtual machines. In this manner, such information may be provided using a console or the like that is familiar to administrators who typically work with a given type of operating system, but may not be familiar with other types of operating systems. The user interface also enables administrators to reconfigure platform and virtual machine resources.

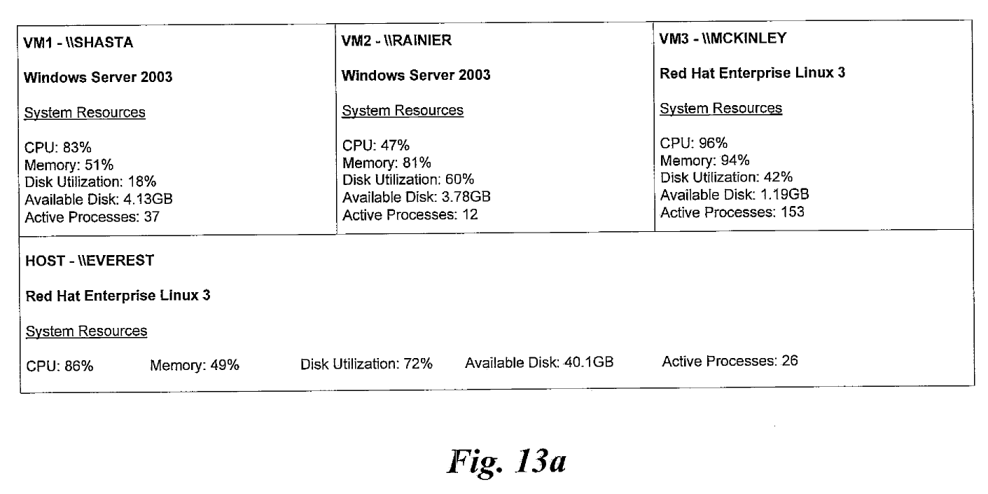

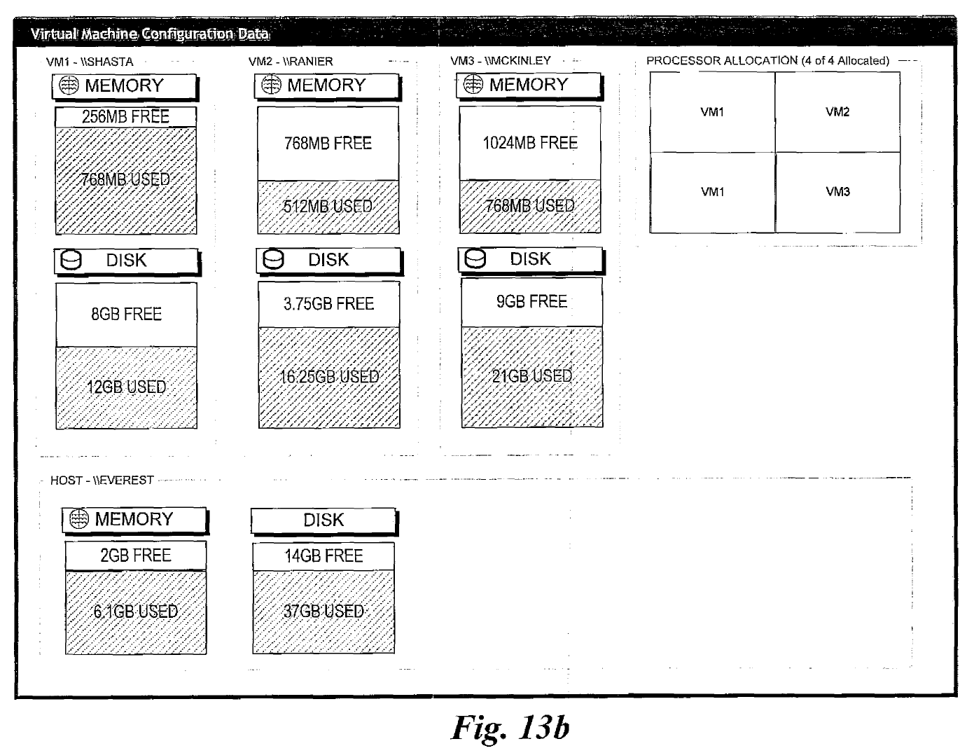

By way of example, FIG. 13a shows one embodiment of a unified user interface for display of the relationships among virtual machines and host operating system and performance data for the host system and each virtual machine. In one implementation, this interface is displayed in a text-based console. Advanced system administrators often run a variety of administrative commands directly from a command line interface; in one implementation, a software agent displays the information shown in FIG. 13a by outputting text characters to the command line console. In another instantiation of the current implementation, the interface is displayed via a windowing interface using the windowing programming interface of the locally running operating system. In the exemplary configuration illustrated in FIG. 13a, the user interface shows performance data relating to three virtual machines; the first, “SHASTA” is running WINDOWS Server 2003, the second “RAINIER” is running WINDOWS Server 2003; the third, “MCKINLEY” is running RED HAT Enterprise LINUX 3, while the host system, “EVEREST”, is running RED HAT Enterprise LINUX 3. The operating system, CPU utilization, memory utilization disk utilization, available disk space, and the number of active processes are displayed in the interface for each of the virtual machines and the host. As shown in FIG. 13a, VM3, “MCKINLEY” is experiencing a problem as illustrated by the high consumption of CPU and memory resources, and large number of active processes. This information is beneficial to the system administrator in determining where a problem may exist.

The various data that may be displayed via the user interface are typically access via mechanisms particular to each type of operating system. For example, WINDOWS-based operating systems provide API's and the like for accessing system operating data, such as exemplified in the figures shown herein. Likewise, LINUX-based operating systems also provide API's and the like for accessing similar data. Such API's are also similarly provided by other types of operating systems not specifically shown herein, such as UNIX-based operating systems. Notably, the API's for the different types of operating systems are different. In view of this difference, the data associated with each operating system instance is gathered by the associated agent, and then the data may be aggregated in a single viewpoint by passing information between applicable agents. In this matter, the information shown in the user interface of FIG. 13a could be provided by an application running on any of EVEREST, SHASTA, RAINIER or MCKINLEY.

As shown in FIG. 13b, a user interface is implemented for displaying the memory and disk allocation on multiple virtual machines and a host, along with the processor allocation data. As discussed above, the virtual memory and disk allocation interface may be implemented so as to be viewable from a software application running on any of a number of operating systems running on virtual machines on a host system, or from an application running on the operating system of the host system itself.

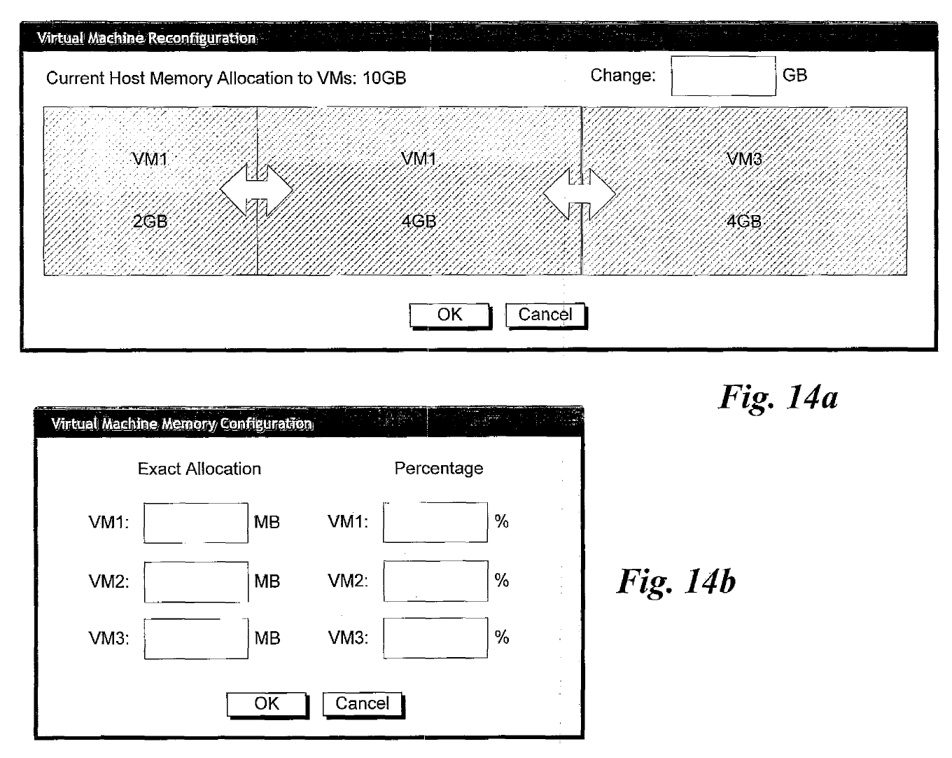

FIG. 14a shows an illustration of an interface for configuring and re-configuring virtual machine memory allocation. The arrows are user-controllable elements of the interface; the user clicks on either arrow and moves the arrow to the left or right via a user input device such as a mouse or touchpad to adjust the virtual machine memory allocation. The user, given sufficient administrative privileges, can also modify the total amount of memory allocated from the host to all virtual machines; uniquely, this action can be performed via the user interface shown in FIG. 14a from any of the virtual machines or the host itself.

FIG. 14b shows an illustration of an alternative interface for configuring virtual machine memory allocation. In this interface, the user enters the amount of memory to be allocated to each virtual machine into the edit boxes. The user can enter an exact number in megabytes of memory, or a percentage, which the software agent then converts into a memory allocation via an appropriate API with its host operating system.

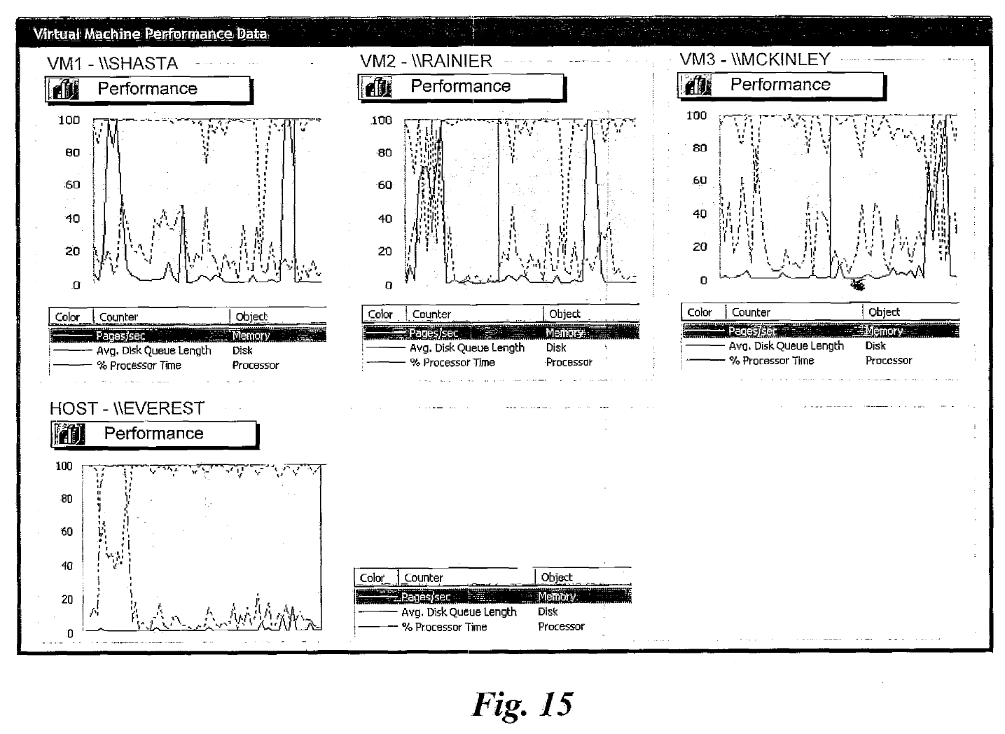

FIG. 15 shows a user interface for viewing virtual machine performance data for multiple virtual machines and their host, from any virtual machine or the host. In FIG. 15, memory, disk, and processor related performance data is shown. More specifically, for memory, the number of memory pages swapped in and out per second is shown; for disk, the average disk queue length, and for processor, the percentage of processor utilized for a given virtual machine. This interface may also be displayed by an agent running on the host system itself. The result is that the user may view performance data for any given virtual machine, or the host itself, from any given virtual machine, or from the host, regardless of underlying operating system.

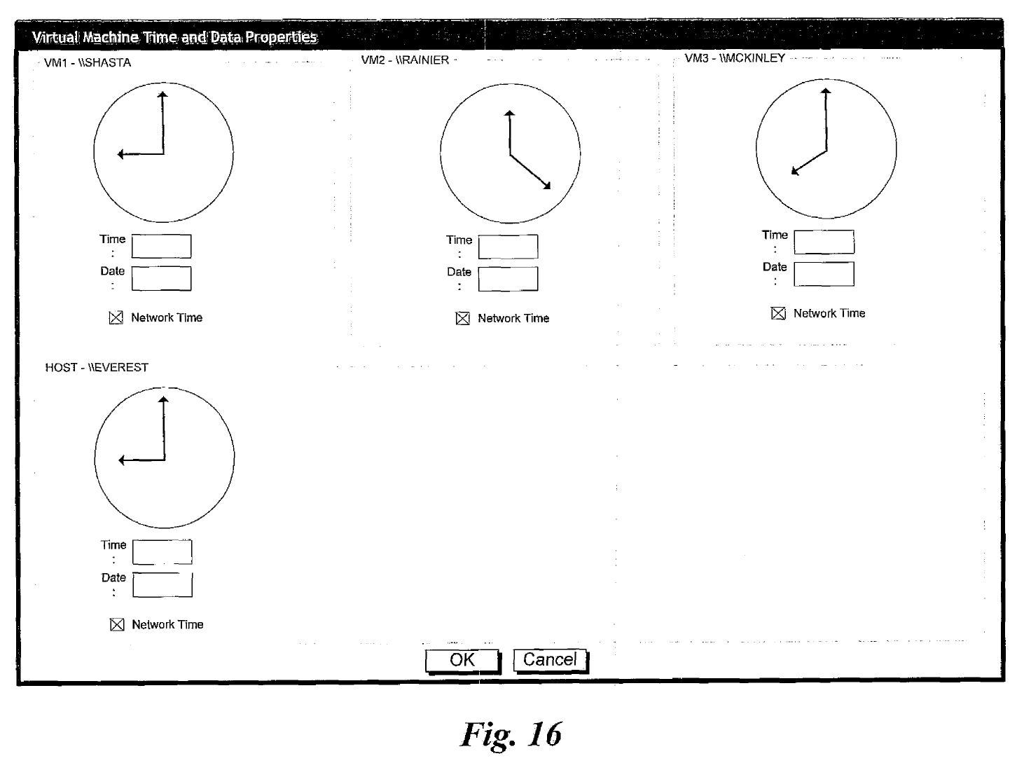

FIG. 16 is an illustration of an interface for viewing the time and date of multiple virtual machines and the host, and modifying the time, date, and use of the network time protocol (NTP) for one or more virtual machines or the host. Different virtual machines may have different times set on them, which can result in, for example, subtle synchronization problems between user account login systems that are difficult for administrators to diagnose. Through the interface shown in FIG. 16, an administrator can easily set the date and time to correct this problem. Or the administrator can set the use of NTP, which causes the selected virtual machine or host to synchronize its clock with a time server on the network.

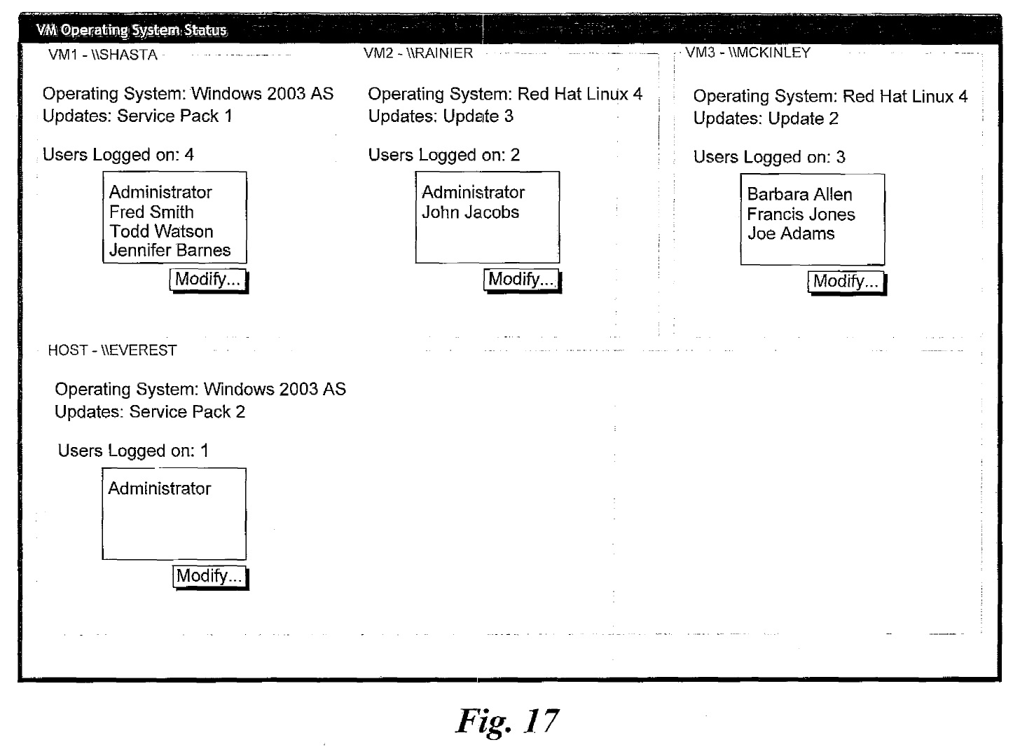

FIG. 17 is a drawing illustrating virtual machine and host operating system status and logged on users for multiple virtual machines or the host, which interface can be accessed and displayed from any virtual machine or the host. The user can click on the Modify button for any virtual machine or the host to force the log-off of another user (as long as the user taking the action has the proper administrative privileges to perform the action). As discussed above, the various data shown in the exemplary user interfaces illustrated herein may be accessed through various mechanisms provided by the underlying operating system of each VM and host. For example, the user interfaces shown in FIGS. 13a, 13b, 14a, 14b, 15, 16, and 17 may be displayed, in one implementation, via calls to the underlying operating system display application programming interface. In an alternative implementation, the user interfaces may be implemented via Dynamic HTML (DHTML) pages that are displayed and accessed via any of the commonly available web browsers, such as Internet Explorer, Firefox, Opera, etc. In general, use of such display API's and DHTML pages are known to those skilled in the art, and thus further details are not provided herein in order to not obscure features of the exemplary embodiments.

The machine instructions comprising the software components for enabling various agent operations discussed herein will likely be distributed on floppy disks or CD-ROMs (or other memory media) and stored in the hard drive until loaded into random access memory (RAM) for execution by the CPU. In some instance, all or a portion of the machine instructions may be pre-loaded on a computing platform (e.g., server or the like). Optionally, all or a portion of the machine instructions may be loaded via a computer network.

The firmware instructions comprising the firmware-based components will generally be stored on corresponding non-volatile rewritable memory devices, such as flash devices, EEPROMs, and the like. Firmware instructions embodied as a carrier wave may also be downloaded over a network and copied to a firmware device (e.g., “flashed” to a flash device), or may be originally stored on a disk media and copied to the firmware device.

Thus, embodiments of this invention may be used as or to support firmware and software instructions executed upon some form of processing core (such as the CPU of a computer) or otherwise implemented or realized upon or within a machine-readable medium. A machine-readable medium includes any mechanism for storing or transmitting information in a form readable by a machine (e.g., a computer). For example, a machine-readable medium can include such storage means such as a read only memory (ROM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

What is claimed is:

1. A method, comprising:
enabling a user to view administrative data produced by multiple operating systems running on respective virtual machines running on a host platform via a unified user interface,
wherein the multiple operating systems comprise at least two different types of operating systems.

2. The method of claim 1, wherein at least one operating system comprises a MICROSOFT WINDOWS-based operating system and at least one operating system comprises a LINUX-based operating system.

3. The method of claim 2, wherein the unified user interface is hosted by an instance of a WINDOWS-based operating system.

4. The method of claim 2, wherein the unified user interface is hosted by an instance of a LINUX-based operating system.

5. The method of claim 1, wherein the virtual machines are hosted by a virtual machine platform running on a host operating system, and the unified user interface further enables the user to view administrative information produced by the host operating system.

6. The method of claim 1, wherein the administrative data includes performance data corresponding to the performance of the multiple operating systems running on the virtual machines.

7. The method of claim 1, wherein the administrative data includes event data corresponding to events associated with operation of the multiple operating systems running on the virtual machines.

8. The method of claim 1, wherein the administrative data includes user data corresponding users of the multiple operating systems running on the virtual machines.

9. The method of claim 1, wherein the administrative data includes resource data corresponding to at least one of allocation and consumption of resources respectively associated with the multiple operating systems running on the virtual machines.

10. The method of claim 9, further comprising enabling a user to reallocate resources associated with at least one operating system via a user interface.

11. The method of claim 1, wherein the virtual machines are hosted by a virtual machine platform running on a host operating system, the method further comprising:
employing a host operating system agent and an agent running on each virtual machine to enable information to be exchanged between the operating systems running on the virtual machines and the host operating system.

12. The method of claim 11, further comprising employing at least one application program interface to enable communication between the host operating system agent and at least one agent running on a virtual machine.

13. The method of claim 11, further comprising enabling agents running on the virtual machines to communicate with one another in a peer-to-peer manner.

14. The method of claim 11, further comprising employing a network protocol to enable communication between the host operating system agent and at least one agent running on a virtual machine.

15. The method of claim 1, further comprising:
employing at least one firmware-based agent to enable information to be exchanged between operating systems running on virtual machines and an application hosting the unified user interface.

16. The method of claim 1, further comprising hosting the virtual machines via a virtual machine platform comprising an application hosted by an operating system running on platform hardware.

17. The method of claim 16, wherein the operating system running on the platform hardware comprises a MICROSOFT WINDOWS-based operating system.

18. The method of claim 16, wherein the operating system running on the platform hardware comprises a LINUX-based operating system.

19. The method of claim 1, wherein the virtual machines are hosted via a firmware-based virtual machine manager.

20. The method of claim 1, further comprising employing an agent running on a light-weight core in a multi-core processor to facilitate communication between at least one of the operating systems and the unified user interface.

21. The method of claim 1, wherein the unified user interface enables the operator to re-allocate resources associated with underlying platform hardware amongst multiple virtual machines.

22. A machine readable medium to provide instructions to perform operations upon execution comprising:
generating a unified interface to enable a user to view administrative data produced by multiple operating systems running on respective virtual machines running on a host platform via a unified user interface,
wherein the multiple operating systems comprise at least two different types of operating systems.

23. The machine readable medium of claim 22, wherein the virtual machines are hosted by a virtual machine platform running on a host operating system, and the unified user interface further enables the user to view administrative information produced by the host operating system.

24. The machine readable medium of claim 23, wherein a first portion of the instructions are embodied in a host operating system agent configured to run on the host operating system, and a second portion of the instructions are embodied as an agent configured to run on one of a virtual machine or an operating system hosted by a virtual machine.

25. The machine readable medium of claim 24, further comprising sets of instructions comprising application program interfaces that are configured to support communication between the host operating system agent and an agent running on a virtual machine.

26. The machine readable medium of claim 24, further comprising sets of instructions comprising application program interfaces that are configured to support communication between the host operating system agent and an agent running on an operating system hosted by a virtual machine.

27. The machine readable medium of claim 24, further comprising sets of instructions comprising network software components that are configured to support communication between the host operating system agent and one of an operating system hosted by a virtual machine or an agent running on the operating system hosted by the virtual machine.

28. The machine readable medium of claim 24, wherein an agent corresponding to the second portion of instructions is enabled to communicate with another agent in a peer-to-peer manner.

29. The machine readable medium of claim 24, wherein the host operating system comprises a MICROSOFT WINDOWS-based operating system, and an agent comprising the second portion of instructions is configured to interface with a non-MICROSOFT WINDOWS-based operating system

30. The machine readable medium of claim 24, wherein the non-MICROSOFT WINDOWS-based operating system comprises a LINUX-based operating system.
